(19) United States
(12) Patent Application Publication
(10) Pub. No.: US 2013/0162078 A1
(43) Pub. Date: Jun. 27, 2013

(54) SPINDLE MOTOR

(71) Applicant: Kyoung Soo Yang, Gyunggi-do (KR)

(72) Inventor: Kyoung Soo Yang, Gyunggi-do (KR)

(73) Assignee: SAMSUNG ELECTRO-MECHANICS CO., LTD., Gyunggi-do (KR)

(21) Appl. No.: 13/408,801

(22) Filed: Feb. 29, 2012

(30) Foreign Application Priority Data
Dec. 23, 2011 (KR) 1020110140921

(51) Int. Cl. H02K 7/08

(52) U.S. Cl. 310/90

(57) ABSTRACT

Disclosed herein is a coupling structure for coupling a stopper supporting a hub and a sleeve of a spindle motor to a protrusion part of the hub. Particularly, coupling force between the stopper and the protrusion part of the hub is improved, thereby making it possible to improve reliability in coupling between the hub and the sleeve. In addition, it is possible to maintain coupling reliability of an assembly of the hub and the sleeve against vibration generated at the time of driving of the motor, external impact, or the like.

### CROSS REFERENCE TO RELATED APPLICATION

This application claims the benefit of Korean Patent Application No. 10-2011-0140921, filed on Dec. 23, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor, which belongs to a brushless-DC motor (BLDC), has been widely used as a laser beam scanner motor for a laser printer, a motor for a floppy disk drive (FDD), a motor for an optical disk drive such as a compact disk (CD) or a digital versatile disk (DVD), or the like, in addition to a motor for a hard disk drive.

Recently, in a device such as a hard disk drive requiring high capacity and high speed driving force, a spindle motor including a fluid dynamic pressure bearing having lower driving friction as compared to an existing ball bearing has generally been used in order to minimize generation of noise and non repeatable run out (NRRO), which is vibration generated at the time of use of a ball bearing. In the fluid dynamic pressure bearing, a thin oil film is basically formed between a rotor and a stator, such that the rotor and the stator are supported by pressure generated at the time of rotation. Therefore, the rotor and stator do not contact each other, such that frictional load is reduced. In the spindle motor using the fluid dynamic pressure bearing, lubricating oil (hereinafter, referred to as an ‘operating fluid) maintains a shaft of the motor rotating a disk only with dynamic pressure (pressure returning oil pressure to the center by centrifugal force of the shaft). Therefore, the spindle motor using the fluid dynamic pressure bearing is distinguished from a ball bearing spindle motor in that the shaft is supported by a shaft ball made of iron.

When the fluid dynamic pressure bearing is used in the spindle motor, the rotor is supported by the fluid, such that a noise amount generated in the motor is small, power consumption is low, and impact resistance is excellent.

At the time of assembling of the spindle motor according to the prior art, a hub of the spindle motor is coupled to the shaft, and a base mounted with a core having a winding coil wound therearound is coupled to an assembly to which the hub is coupled. The coupling of the assembly including the hub is released due to vibration, or the like, generated at the time of driving of the spindle motor or some components are separated from the spindle motor due to external impact, or the like, such that operational reliability of the spindle motor is deteriorated. In addition, the hub coupled to the shaft does not endure the vibration generated at the time of the driving of the spindle motor due to weakening of coupling force of the hub, such that the hub may be separated upwardly from the shaft in an axial direction. Further, even in the case in which a stopper for supporting an assembly including the hub and a sleeve is formed, coupling force between the hub and the stopper is weak, such that it is difficult to fix and support the hub and the sleeve, and an adhesive filled at the time of coupling between the hub and stopper flows in a shaft system forming a fluid dynamic pressure bearing part, such that foreign materials are mixed with an operating fluid.

### SUMMARY OF THE INVENTION

The present invention has been made in an effort to provide a spindle motor in which a stopper is coupled to an inner side of a protrusion part protruded downwardly of a hub in an axial direction to thereby improve coupling force of the hub and operational performance and reliability of the spindle motor, and a coupling structure of a coupling surface between the protrusion part of the hub and the stopper is changed in order to increase coupling force therebetween to thereby improve accuracy and reliability in coupling of the spindle motor.

According to a preferred embodiment of the present invention, there is provided a spindle motor including: a shaft becoming the rotational center of a motor rotor; a sleeve receiving the shaft therein and rotatably supporting the shaft; a hub having the shaft coupled integrally therewith at a central portion thereof, coupled to the shaft at an upper portion of the shaft in an axial direction so as to correspond to one end surface of the sleeve, and having a protrusion part protruded downwardly in the axial direction; and a stopper inserted into an inner side of the protrusion part in order to fix and support the hub at a lower portion of the hub in the axial direction, wherein the stopper includes a screw thread protruded outwardly on an outer peripheral surface thereof and the protrusion part of the hub includes a screw coupling groove formed in an inner side surface thereof corresponding to the screw thread, the screw coupling groove having the screw thread coupled thereto.

The screw thread may be continuously formed along the outer peripheral surface of the stopper.

The stopper may have a ring shape.

A coupling surface of the stopper on which the stopper and the protrusion part are coupled to each other or a coupling surface of the inner side surface of the protrusion part may be provided with at least one injection hole in the axial direction.

The spindle motor may further include a base coupled to an outer side surface of the sleeve so as to support the sleeve and having a core mounted on an inner side surface thereof, the core having a coil wound therearound, wherein the hub includes a rotor magnet formed at a position thereof corresponding to the core.

### BRIEF DESCRIPTION OF THE DRAWINGS

FIG. 1 is an exploded perspective view showing a structure in which a stopper is coupled to an assembly including a hub according to a preferred embodiment of the present invention;

FIG. 2 is a cross-sectional view of the assembly including the hub according to the preferred embodiment of the present invention;

FIG. 3 is an enlarged view of the part A of FIG. 2;

FIGS. 4A and 4B are perspective views of the stopper according to the preferred embodiment of the present invention;

FIG. 5 is an exploded perspective view of a spindle motor according to the preferred embodiment of the present invention; and

FIG. 6 is a cross-sectional view of the spindle motor according to the preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

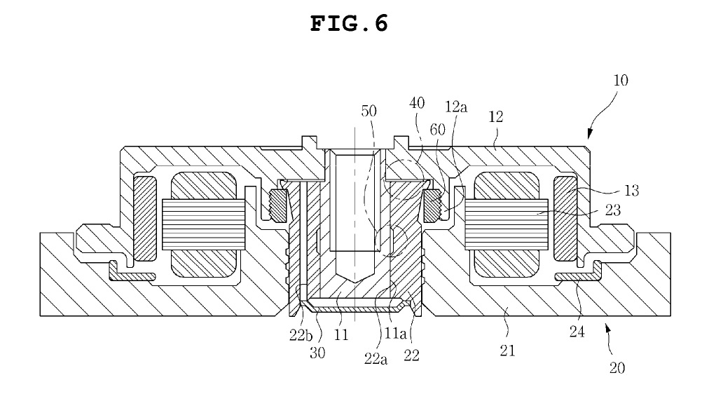

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the terms “first”, “second”, “one surface”, “the other surface” and so on are used to distinguish one element from another element, and the elements are not defined by the above terms. Further, in the present invention, an “axial direction is based on an extension direction of a length direction of a shaft becoming the rotation center of a motor. As shown in FIG. 6, upper and lower portions in the extension direction of the shaft are defined as upper and lower portions in the axial direction. In describing the present invention, a detailed description of related known functions or configurations will be omitted so as not to obscure the gist of the present invention.

Hereinafter, preferred embodiments of the present invention will be described in detail with reference to the accompanying drawings.

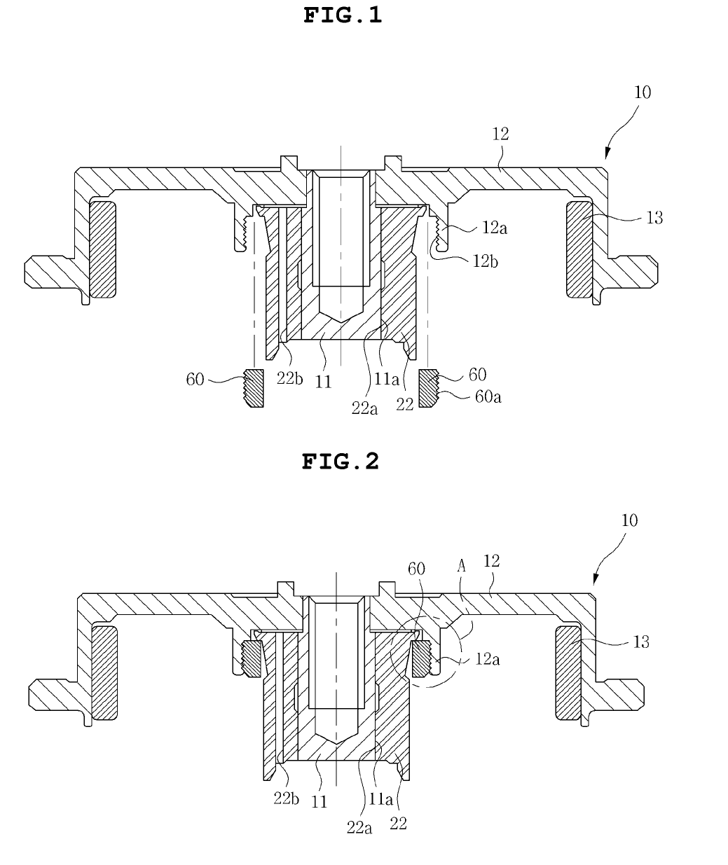

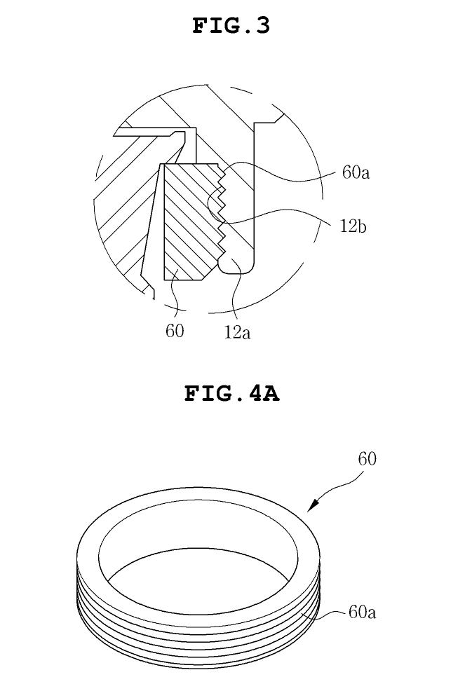

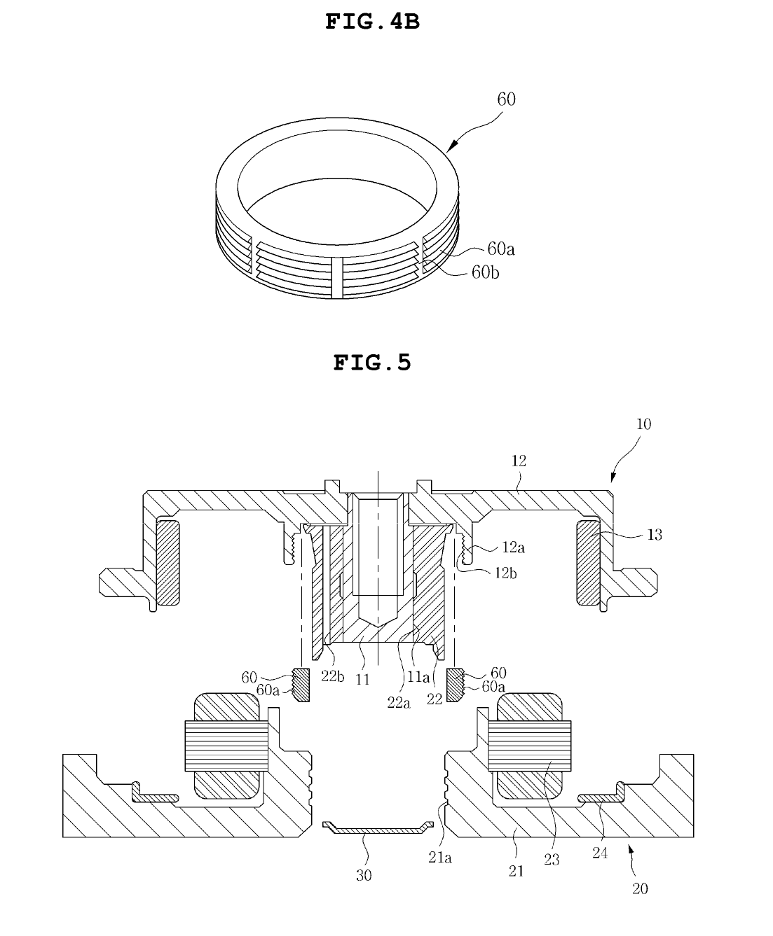

FIG. 1 is an exploded perspective view showing a structure in which a stopper is coupled to an assembly including a hub according to a preferred embodiment of the present invention; FIG. 2 is a cross-sectional view of the assembly including the hub according to the preferred embodiment of the present invention; FIG. 3 is an enlarged view of the part A of FIG. 2; FIGS. 4A and 4B are perspective views of the stopper according to the preferred embodiment of the present invention; and FIG. 5 is an exploded perspective view of a spindle motor according to the preferred embodiment of the present invention.

The spindle motor according to the preferred embodiment of the present invention is configured to include a shaft 11 becoming the rotational center of a motor rotor 10, a sleeve 22 receiving the shaft 11 therein and rotatably supporting the shaft 11, a hub 12 having the shaft 11 coupled integrally therewith at a central portion thereof, coupled to the shaft 11 at an upper portion of the shaft 11 in the axial direction so as to correspond to one end surface of the sleeve 22, and having a protrusion part 12a protruded downwardly in the axial direction, and a stopper 60 inserted into an inner side of the protrusion part 12a in order to fix and support the hub 12 at a lower portion of the hub 12 in the axial direction, wherein the stopper 60 includes a screw thread 60a protruded outwardly on an outer peripheral surface thereof and the protrusion part 12a of the hub 12 includes a screw coupling groove 12b formed in an inner side surface thereof corresponding to the screw thread 60a, the screw coupling groove 12b having the screw thread 60a coupled thereto.

Particularly, according to the preferred embodiment of the present invention, the stopper 60 is coupled to the hub 12 in order to fix and support the hub 12 coupled to the shaft 11 from the upper portion of the shaft 11 in the axial direction toward the lower portion thereof. The stopper 60 is coupled to and seated on an inner side surface of the protrusion part 12a protruded downwardly of the hub 12 in the axial direction. The stopper 60 is coupled to the inner side surface of the protrusion part 12a of the hub 12 to fix and support the coupling of an assembly including the hub 12 and the sleeve 22. The coupling of the hub 12 of the spindle motor may be separated due to vibration generated at the time of driving of the spindle motor, external impact, or the like. The present invention is to improve coupling force between the stopper 60 and the protrusion part 12a of the hub 12 to fix and support stably the coupling of the entire assembly including the hub 12 and the sleeve 22, thereby improving operational performance and reliability of the spindle motor.

Hereinafter, a configuration of the spindle motor including the stopper 60 and a coupling position and a feature of the stopper 60 will be described.

The shaft 11 becomes the center axis around which the spindle motor rotates and has generally a cylindrical shape. Although the accompanying drawings show that a thrust dynamic bearing part 40 is formed between an upper end surface of the sleeve 22 in the axial direction and one surface of the hub 12 facing the upper end surface of the sleeve 22, a thirst plate (not shown) may be insertedly installed in an upper or lower end portion of the shaft so as to be perpendicular to the axial direction. In order to fix the thrust plate to the shaft 11, separate laser welding, or the like, may be used. However, it is obvious to those skilled in the art that the thrust plate may be press-fitted into and be coupled to the shaft 11 by being applied with a predetermined pressure. In order to form the thrust dynamic pressure bearing part 40 by a fluid dynamic pressure bearing, a dynamic pressure generation groove (not shown) may be formed in the thrust plate or a surface facing the sleeve 22.

The sleeve 22, which is to rotatably support the shaft 11, has a generally hollow cylindrical shape, and includes a radial dynamic pressure bearing part 50 by a fluid dynamic pressure bearing formed between an outer peripheral surface thereof and an inner peripheral surface of the shaft 11 facing the outer peripheral surface thereof. In order to form the radial dynamic pressure bearing part 50, a radial dynamic pressure generation groove (not shown) is formed in an inner peripheral surface 22a of the sleeve 22 facing an outer peripheral surface 11a of the shaft 11, and an operating fluid (for example, oil, or the like) is stored between the inner peripheral surface 22a of the sleeve 22 and the outer peripheral surface 11a of the shaft 11. The radial dynamic pressure generation groove generates fluid dynamic pressure using the fluid stored between the sleeve 22 and the 11 at the time of rotation of the shaft 11, such that the shaft 11 and the sleeve 22 are maintained in a state in which they do not contact each other. The radial dynamic pressure generation groove may also be formed in the outer peripheral surface 11a of the shaft 11 forming the radial dynamic pressure bearing part 50 by the fluid dynamic pressure bearing.

The sleeve 22 may further include a circulation hole 22b formed therein in order to prevent pressure unbalance by circulating the operating fluid and discharge air bubbles and foreign materials. The operating fluid forming the fluid dynamic pressure bearing is smoothly circulated through the circulation hole 22b, thereby making it possible to further improve operational reliability of the motor.

The hub 12, which is to mount and rotate an optical disk (not shown) or a magnet disk (not shown) thereon, has the shaft 11 coupled integrally therewith at the center thereof and is coupled to the upper portion of the shaft 11 so as to correspond to the upper end surface of the sleeve 22 in the axial direction. A rotor magnet 13 is formed so as to face to a core 23 of a base 21 in a radial direction. The core 23 generates a magnetic flux while forming a magnetic field when current flows. The rotor magnet 13 facing the core 23 includes repeatedly magnetized N and S poles to thereby form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12.

The stopper 60 is inserted into the inner side of the protrusion part 12a in order to fix and support the hub 12 at the lower portion thereof in the axial direction. As shown in FIGS. 1 and 2, the hub 12 is coupled to the shaft 11 from the upper portion thereof in the axial direction toward the lower portion thereof. The hub 12 includes the protrusion part 12a formed integrally therewith and protruded downwardly in the axial direction, and the stopper 60 is fixed and coupled to the inner side surface of the protrusion part 12a of the hub 12. Here, the protrusion part 12a is formed integrally with the hub and is coupled to the stopper 60, thereby making it possible to improve coupling force of the hub 12. Alternatively, the protrusion part 12 may be formed as a separate member coupled to the hub 12.

The stopper 60 is coupled to the inner side surface of the protrusion part 12a of the hub 12 in a screwing scheme. Generally, the stopper 60 and the inner side surface of the protrusion part 12a are bonded to each other by a bonding process. In this case, the hub 12 is separated or partially released from the coupling due to vibration generated at the time of driving of the motor or external impact, such that the operational reliability of the motor is deteriorated. Therefore, according to the preferred embodiment of the present invention, the stopper 60 includes the screw thread 60a formed on the outer peripheral surface thereof and the protrusion part 12a of the hub 12 includes the screw coupling groove 12b formed in the inner side surface thereof, such that the stopper 60 and the hub 12 are coupled to each other in a screwing scheme, thereby making it possible to improve the coupling force between the stopper 60 and the hub 12. According to the prior art, a sufficient amount of adhesive should be injected on a coupling surface between the stopper 60 and the protrusion part 12a in order to increase the coupling force of the stopper 60. In this case, the adhesive is introduced into the motor, such that it is mixed with the operating fluid. However, the screw thread 60a is formed on the outer peripheral surface of the stopper 60 to improve the coupling force between the stopper 60 and the hub 12, such that the use of a separate adhesive is omitted or only a small amount of adhesive is used, thereby making it possible to prevent the adhesive from being introduced into the motor.

In addition, the screw thread 60a formed in the stopper 60 may be continuously formed along the outer peripheral surface of the stopper 60. Considering that the stopper 60 is generally manufactured in a ring shape, the screw thread 60a is formed to be protruded in a ring shape along the outer peripheral surface of the stopper 60 (See FIG. 4A).

In addition, a coupling surface of the stopper 60 on which the stopper 60 and the protrusion part 12a are coupled to each other or a coupling surface of the inner side surface of the protrusion part 12a may be provided with an injection hole 60b into which the adhesive is injected in the axial direction. The injection hole 60b formed in the axial direction allows the adhesive to be smoothly injected into an inner portion thereof when a bonding operation is additionally performed at the time of coupling between the stopper 60 and the protrusion part 12a of the hub 12. As shown in FIG. 4B, the injection hole 60b may be formed in the axial direction on a surface on which the screw thread 60a of the stopper 60 is formed. The adhesive is injected into the injection hole 60b, such that an adhesion area between the stopper 60 and the protrusion part 12a may be increased and the adhesive may be uniformly applied to an inner side of the coupling surface.

In addition, the spindle motor according to the preferred embodiment of the present invention further includes a base 21 coupled to an outer side surface of the sleeve 22 so as to support the sleeve 22 and having the core 23 mounted on an inner side surface thereof, the core having a coil wound therearound, wherein the hub 12 includes a rotor magnet 13 formed at a position thereof corresponding to the core 23.

The base 21 has one side surface coupled to the outer side surface of the sleeve 22 so that the sleeve 22 including the shaft 11 is coupled to an inner side thereof. The base 21 has the core 23 coupled to the other side surface thereof, which is an opposite side to one side surface thereof, at a position corresponding to that of the rotor magnet 13 formed on the hub 12, wherein the core 23 has a winding coil wound therearound. The base 21 may serve to support the entire structure of the spindle motor at a lower portion of the spindle motor and be manufactured by press processing or die-casting. In the case in which the base 21 is manufactured by the press processing, the base 21 may be made of various metal materials such as aluminum, steel, and the like, particularly, a material having rigidity. As shown in FIG. 5, the base 21 and the sleeve 22 may be assembled to each other by applying an adhesive to an inner surface of the base 21 or an outer surface of the sleeve 22. A bonding groove 21a is further formed in a bonding surface of the base 21 on which the base 21 and the sleeve 22 are bonded to each other to increase a bonding area, thereby making it possible to improve coupling force. A conductive adhesive (not shown) for conduction between the base 21 and the sleeve 22 may be connected to and formed on a lower end surface of a portion at which the base 21 and the sleeve 22 are bonded to each other. The conductive adhesive is formed to allow excessive charges generated at the time of operation of the motor to flow out through the base 21, thereby making it possible to improve operational reliability of the motor.

The core 23 is generally formed by stacking a plurality of thin metal plates and is fixedly disposed on the base 21 including a flexible printed circuit board (not shown). A plurality of through-holes (not shown) may be formed in a lower end surface of the base 21 so as to correspond to the coil led from the winding coil, and the coil led through the through-holes may be soldered and electrically connected to the flexible printed circuit board. An insulating sheet (not shown) may be formed at an inlet portion of the through-hole in order to insulate the through-hole and the coil passing through the through-hole from each other.

The hub 12, which is to mount and rotate an optical disk (not shown) or a magnet disk (not shown) thereon, has the shaft 11 coupled integrally therewith at the center thereof and is coupled to the upper portion of the shaft 11 so as to correspond to the upper end surface of the sleeve 22 in the axial direction. The rotor magnet 13 is formed so as to correspond to the core 23 of the base 21 in a radial direction. The core 23 generates a magnetic flux while forming a magnetic flux when current flows. The rotor magnet 13 facing the core 23 includes repeatedly magnetized N and S poles to thereby form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12.

As shown in FIGS. 5 and 6, the cover member 30 is coupled to the sleeve 22 in order to cover an axial lower end surface of the sleeve 22 including the shaft 11. The cover member 30 may include a dynamic pressure generation groove (not shown) formed in an inner side surface facing a lower end surface of the shaft 11 to form the thrust dynamic pressure bearing part 40. The cover member 30 may have a structure in which it is coupled to a distal end of the sleeve 22, such that the oil, which is the operating fluid, may be stored therein.

Components of the spindle motor according to the preferred embodiment of the present invention and an operation relationship therebetween will be briefly described below with reference to FIG. 6.

A rotor 10 includes the shaft 11 becoming a rotation axis and rotatably formed and the hub 12 having the rotor magnet 13 attached thereto, and a stator 20 includes the base 21, the sleeve 22, the core 23, and a pulling plate 24. Each of the core 23 and the rotor magnet 13 is attached to an outer side of the base 21 and an inner side of the hub 12 while facing each other. When current is applied to the core 23, a magnetic flux is generated while a magnetic field is formed. The rotor magnet 13 facing the core 23 includes repeatedly magnetized N and S poles to thereby form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12, such that the spindle motor according to the preferred embodiment of the present invention is driven. In addition, in order to prevent floating at the time of driving of the motor, the pulling plate 24 is formed on the base 21 so as to correspond to the rotor magnet 13 in the axial direction. The pulling plate 24 and the rotor magnet 13 have attractive force acting therebetween, thereby making it possible to stably rotate the motor.

Particularly, according to the preferred embodiment of the present invention, the assembly of the hub 12 and the sleeve 22 is firmly fixed and supported by the stopper 60, thereby making it possible to prevent separation of the coupling member such as the hub 12, or the like, due to the vibration generated at the time of the driving of the motor or the external impact. In addition, the vibration generated at the time of the driving of the motor is reduced to improve operational performance of the motor and durability of the motor, thereby making it possible to increase a lifespan of the motor.

As set forth above, according to the preferred embodiments of the present invention, the screw coupling groove is formed in the inner side surface of the protrusion part of the hub and the screw thread is formed on the coupling surface of the stopper corresponding thereto, thereby making it possible to improve coupling force of the assembly including the hub and the sleeve.

In addition, the inner side surface of the protrusion part of the hub and the stopper are coupled to each other in the screwing scheme, thereby making it possible to prevent the adhesive for a bonding operation from flowing in the shaft system forming the fluid dynamic pressure bearing.

Further, the inner side surface of the protrusion part of the hub and the stopper are coupled to each other in the screwing scheme, such that an amount of adhesive required for coupling is reduced, thereby making it possible to reduce an amount of outgas that may be generated in the motor after being assembled.

Furthermore, the coupling between the hub and the sleeve of the spindle motor is fixed and supported to improve coupling force between the rotor and the stator, thereby making it possible to prevent the bearing assembly from being damaged or disassembled due to external impact or vibration.

Moreover, the stable coupling force of the assembly including the hub, which is the rotor of the spindle motor, is maintained, thereby making it possible to secure reliability in the driving of the spindle motor.

In addition, the stopper is coupled and fixed to the inner side surface of the protrusion part protruded downwardly of the hub in the axial direction, thereby making it possible to improve coupling force between the hub and the sleeve.

Further, the stopper is inserted from the lower portion in the axial direction into the inner side surface of the protrusion part of the hub to reduce the vibration due to the driving of the motor or the external impact, thereby making it possible to maintain the stable driving of the spindle motor.

Although the preferred embodiments of the present invention have been disclosed for illustrative purposes, they are for specifically explaining the present invention and thus a spindle motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a shaft becoming the rotational center of a motor rotor;
a sleeve receiving the shaft therein and rotatably supporting the shaft;
a hub having the shaft coupled integrally therewith at a central portion thereof, coupled to the shaft at an upper portion of the shaft in an axial direction so as to correspond to one end surface of the sleeve, and having a protrusion part protruded downwardly in the axial direction; and
a stopper inserted into an inner side of the protrusion part in order to fix and support the hub at a lower portion of the hub in the axial direction,
wherein the stopper includes a screw thread protruded outwardly on an outer peripheral surface thereof and the protrusion part of the hub includes a screw coupling groove formed in an inner side surface thereof corresponding to the screw thread, the screw coupling groove having the screw thread coupled thereto.

2. The spindle motor as set forth in claim 1, wherein the screw thread is continuously formed along the outer peripheral surface of the stopper.

3. The spindle motor as set forth in claim 1, wherein the stopper has a ring shape.

4. The spindle motor as set forth in claim 1, wherein a coupling surface of the stopper on which the stopper and the protrusion part are coupled to each other or a coupling surface of the inner side surface of the protrusion part is provided with at least one injection hole in the axial direction.

5. The spindle motor as set forth in claim 1, further comprising a base coupled to an outer side surface of the sleeve so as to support the sleeve and having a core mounted on an inner side surface thereof, the core having a coil wound therearound,
wherein the hub includes a rotor magnet formed at a position thereof corresponding to the core.
